(19) United States
(12) Patent Application Publication
(10) Pub. No.: US 2008/0170325 A1
(43) Pub. Date: Jul. 17, 2008

(54) Disk Centering Assembly And Spindle Hub

(75) Inventors: Kien Wee LAI, San Jose, CA (US); Alex MORARU, Aptos, CA (US); Jui Kiat GOH, Singapore (SG)

Correspondence Address: LAWRENCE Y.D. HO & ASSOCIATES PTE LTD, 30 BIDEFORD ROAD, #02-02, THONGSIA BUILDING, SINGAPORE, 229922, omitted

(73) Assignee: LaserResearch (S) Pte Ltd, Singapore (SG)

(21) Appl. No.: 11/972,638

(22) Filed: Jan. 11, 2008

Related U.S. Application Data
(60) Provisional application No. 60/884,608, filed on Jan. 11, 2007.

(51) Int. Cl. G11B 17/08

(52) U.S. Cl. 360/98.07

(57) ABSTRACT

The present invention provides a centering assembly for centering a plurality of disks being assembled onto a spindle hub, and further provides a spindle hub being capable of centering disks being assembled.

### RELATED APPLICATION

This application claims the benefit under 35 U.S.C. 119(e) of U.S. Provisional Application Ser. No. 60/884,608, filed 11 Jan. 2007 with a title of SPINDLE HUB WITH A MULTIDISK CENTERING DEVICE, which is herein incorporated by reference.

### FIELD OF THE INVENTION

The present invention relates to servowriters, and more particularly to a disk centering assembly for centering multiple disks being assembled on a spindle hub, and further to a spindle hub with a disk centering assembly.

### BACKGROUND OF THE INVENTION

A typical media servowriter comprises a hub and an air-bearing spindle motor with a rotating shaft, wherein the hub is attached to the spindle air bearing so that the hub can be rotated by the rotating shaft of the air-bearing spindle motor. Usually, the hub has the capacity of receiving a disk-stack with multiple disks and spacers. During servo-track writing, the rotary motion of the air-bearing spindle motor spins the hub and hence the disk-stack it carries. Each read-write head is attached to a head suspension device that is connected to an actuator arm. The actuator arm carrying the read-write heads are inserted in-between the disks while reading or writing on the disk surfaces. Thus, a media servowriter writes on multiple disks simultaneously.

It is evident that when the stacked disks are offset from the center of rotation of a spindle, vibrations will be caused, and the resultant vibrations can adversely affect the writing of electronic data and information onto the disk surface. If this information is poorly written onto the disk, it will have a negative impact on the performance of the disk drive that contains this disk. Thus a centering technique for minimizing the offset of disks will be helpful in eliminating or reducing the vibrations of disks. The performance of the disk drive will increase when the information is written more accurately onto the disk with respect to its center of rotation.

Previous attempts to achieve accurate disk centering involve various devices which contacted the outer diameter of the disk in an attempt to position it with respect to the rotational axis of the spindle. This approach had two inherent problems. One is that the rotational axis of the spindle could not be accurately determined; and the other is that the disks are registered in the disk drive by their inner diameter, not the outer diameter. These two problems cause a built-in error that failed the currently available devices to achieve the hoped-for performance gains.

### SUMMARY OF THE INVENTION

The present invention intends to eliminate or minimize the problems associated with current available centering techniques by contacting the same surface of the disk when in the spindle that will be used in the disk drive and using centering fingers in the hub that are machined in place to the same length on the spindle while it is rotating. This guarantees that the spindle rotational axis is coincident with the inner diameter of the disk.

One embodiment of the present invention provides a centering assembly for centering a plurality of disks being assembled onto a spindle hub. The centering assembly comprises a plurality of curved leaf springs for providing means for centering the plurality of disks by contacting their inner diameters, and a curved leaf springs actuator system for operating the plurality of curved leaf springs; thereby the curved leaf springs actuator system controls the contact between the plurality of curved leaf springs and the inner diameter of the disks, resulting in the centering of the disks being assembled on the spindle hub.

In one embodiment of the centering, the plurality of curved leaf springs forms a continuous cylindrical structure. In another embodiment of the centering, the plurality of curved leaf springs forms a non-continuous cylindrical structure.

In one embodiment of the centering assembly, one of the plurality of curved leaf springs is configured to have an intact portion and a plurality of flexible teeth extending from the intact portion, wherein the intact portion has a column of spring mounting holes for the mounting the curved leaf springs, and wherein the plurality of flexible teeth bears a plurality of fingers that are used to contact the inner diameter of the disks during centering. In a further embodiment of the centering assembly, the plurality of flexible teeth is spaced from each other equally.

In another embodiment of the centering assembly, the curved leaf springs actuator system comprises a plurality of actuator rods being positioned at the tips of the flexible teeth, and an actuator rod controlling system for controlling the position of the plurality of actuator rods so that the curved leaf springs can be kept at any point between an extended position to a compressed position, and then the positions of the fingers can be controlled by the plurality of actuator rods. In a further embodiment of the centering assembly, one of the plurality of actuator rods is configured to have a flat surface so as to have a cam-like profile, where the flat surface is oriented roughly tangent to the outer surface of the curved leaf springs so that it does not press the curved leaf springs when in tangent condition.

In another embodiment of the centering assembly, the actuator controlling system comprises a plurality of pinion gears, wherein one pinion gear is attached to the bottom end of one actuator rod, a plurality of gear racks, wherein the side of one gear rack meshes with one gear rack, and wherein the gear rack has a first end being attached with one piston and a second end receiving one return spring; thereby when air pressure is applied to the piston, it moves the pistons and causes the actuator rods to rotate; when air pressure is removed, the return spring forces the gear rack back to its initial position.

Another embodiment of the present invention provides a spindle hub being capable of centering disks being assembled. The spindle hub comprises a centering assembly comprising a plurality of curved leaf springs for providing means for centering the plurality of disks by contacting their inner diameters, and a curved leaf springs actuator system for operating the plurality of curved leaf springs, thereby the curved leaf springs actuator system controls the contact between the plurality of curved leaf springs and the inner diameter of the disks, resulting the centering of the disks being assembled on the spindle hub; a hollow cylindrical spindle hub shaft having a chamber for receiving the centering assembly, wherein the disks are assembled at the outer diameter of the hollow cylindrical spindle hub shaft so that the assembled disks are centered by the centering assembly; and a base being connected to the bottom end of the hollow cylindrical spindle hub shaft, wherein when the base interacts with a motorized spindle, resulting in the rotation of the spindle hub with assembled disks.

In another embodiment of the spindle hub, the plurality of curved leaf springs forms a continuous cylindrical structure. In yet another embodiment of the spindle hub, the plurality of curved leaf springs forms a non-continuous cylindrical structure.

In another embodiment of the spindle hub, one of the plurality of curved leaf springs is configured to have an intact portion and a plurality of flexible teeth extending from the intact portion, wherein the intact portion has a column of spring mounting holes for the mounting the curved leaf springs, wherein the plurality of flexible teeth bears a plurality of fingers that are used to contact the inner diameter of the disks during centering; and wherein the hollow cylindrical spindle hub shaft has a plurality of columns of shaft mounting holes and finger holes, wherein the shaft mounting holes are aligned with the spring mounting holes for mounting the curved leaf springs onto the inner diameter of the hollow cylindrical spindle hub shaft and the finger holes are channels for providing passes for the fingers of the centering assembly.

In another embodiment of the spindle hub, the plurality of flexible teeth is spaced from each other equally; and wherein the plurality of flexible teeth is perpendicular to the spin axis of the spindle hub when the curved leaf springs are assembled inside the chamber of the hollow cylindrical spindle hub shaft. In yet another embodiment of the spindle hub, the fingers are initially manufactured with excessive length, and then the excessive length of the fingers is machined to proper length while the spindle hub is rotated; thereby the ends of the fingers are all equidistant from the center of rotation of the spindle hub.

In another embodiment of the spindle hub, the curved leaf springs actuator system comprises a plurality of actuator rods being positioned at the tips of the flexible teeth; and an actuator rod controlling system for controlling the position of the plurality of actuator rods so that the curved leaf springs can be kept at any point between an extended position to a compressed position, and then the positions of the fingers can be controlled by the plurality of actuator rods.

In another embodiment of the spindle hub, one of the plurality of actuator rods is configured to have a flat surface so as to have a cam-like profile, where the flat surface is oriented roughly tangent to the outer surface of the curved leaf springs so that it does not press the curved leaf springs when in tangent condition.

In another embodiment of the spindle hub, the actuator controlling system comprises a plurality of pinion gears, wherein one pinion gear is attached to the bottom end of one actuator rod, and a plurality of gear racks, wherein the side of one gear rack meshes with one gear rack, and wherein the gear rack has a first end being attached with one piston and a second end receiving one return spring; thereby when air pressure is applied to the piston, it moves the pistons and causes the actuator rods to rotate; when air pressure is removed, the return spring forces the gear rack back to its initial position.

The objectives and advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1 is an isometric view of the spindle hub showing the external configuration in accordance with one embodiment of the present invention.

FIG. 2 shows a perspective view of one of the plurality of the curved leaf springs 8 in accordance with one embodiment of the present invention.

FIG. 3 is a perspective view of the interface of the fingers with a disk in accordance with one embodiment of the present invention.

FIG. 4 shows a perspective view of the actuator rod locations with respect to the leaf springs in accordance with one embodiment of the present invention.

FIG. 5 shows a perspective view of the actuator rod controlling system in accordance with one embodiment of the present invention.

### DETAILED DESCRIPTION OF THE INVENTION

The present invention may be understood more readily by reference to the following detailed description of certain embodiments of the invention.

Throughout this application, where publications are referenced, the disclosures of these publications are hereby incorporated by reference, in their entireties, into this application in order to more fully describe the state of art to which this invention pertains.

In the following detailed description, specific details are set forth in order to provide a thorough understanding of the invention. However, it will be understood by those skilled in the relevant art that the present invention may be practiced without these specific details. In other instances, well-known methods, procedures, components, and materials have not been described in detail so as not to obscure the present invention.

The present invention provides a centering mechanism to ensure that disks are centered around the rotation axis during the assembly process and further provides a spindle hub comprising such centering mechanism. Briefly, the spindle hub comprises a centering assembly for centering the disks being assembled on the spindle hub, and a hollow cylindrical spindle hub shaft for accommodating a centering assembly. It is to be noted that the following description will cite embodiments with specific configurations and specifications for illustrating the principles of the present invention. However, the present invention is not limited to such embodiments; instead, it can be practiced with any perceivable variations.

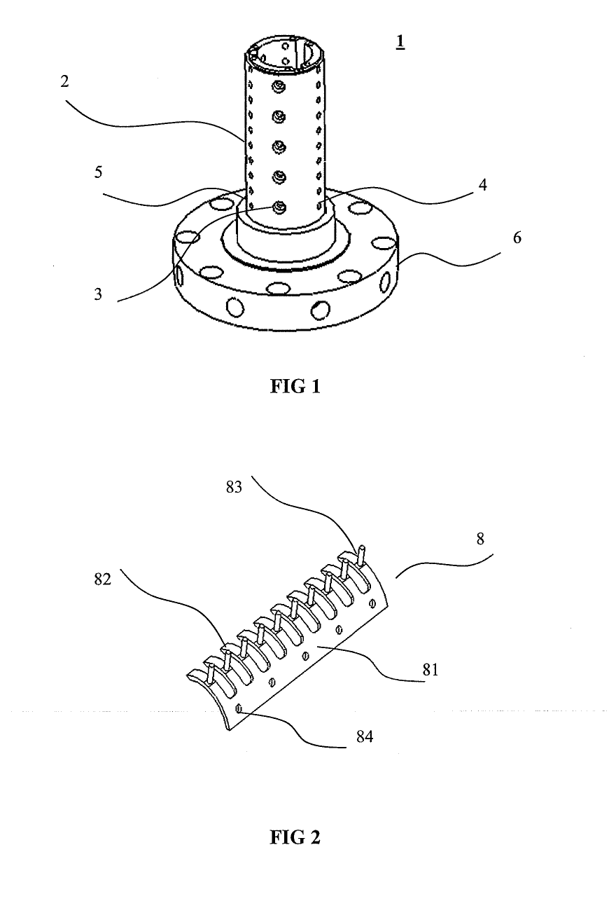

Now referring to FIG. 1, there is provided an isometric view of the spindle hub in accordance with one embodiment of the present invention. As shown in FIG. 1, the spindle hub 1 comprises a hollow cylindrical spindle hub shaft 2 and a base 6, wherein the base 6 interacts with a motorized spindle (not shown) that rotates the spindle hub with loaded disks. The hollow cylindrical spindle hub shaft 2 has a plurality of columns of shaft mounting holes 3 and finger holes 4, where the shaft mounting holes 3 are used for mounting the centering assembly described in detail below and the finger holes 4 are channels for providing passes for the fingers of the centering assembly. FIG. 1 shows three columns of shaft mounting holes and finger holes. Each column of the shaft mounting holes and finger holes has a plurality of holes that are spaced from each other.

As mentioned above, the spindle hub 1 comprises a centering assembly for centering the disks being assembled onto the spindle hub. In one embodiment, the centering assembly comprises a plurality of curved leaf springs 8, and a curved leaf springs actuator system.

Now referring to FIG. 2, there is provided a perspective view of one of the plurality of the curved leaf springs 8 in accordance with one embodiment of the present invention. One curved leaf spring is configured to have an intact portion 81 and a plurality of flexible teeth 82 extending from the intact portion, where the plurality of flexible teeth is spaced from each other equally. In one embodiment, the plurality of flexible teeth is perpendicular to the spin axis of the spindle hub when the curved leaf springs are assembled inside the chamber of the hollow cylindrical spindle hub shaft 2. One curved leaf spring further comprises a plurality of fingers 83 extending from the plurality of flexible teeth, where the fingers refers to any protruding objects that are suitable for the present invention. In one embodiment, one flexible tooth has one finger on it. One curved leaf spring further comprises a plurality of spring mounting holes 84 formed on the intact portion for mounting the curved leaf spring to the hollow cylindrical spindle hub shaft. In one embodiment, the plurality of spring mounting holes are configured into a column that are compatible with the shaft mounting holes 3 on the hollow cylindrical spindle hub shaft 2. In one embodiment, all spring mounting holes are equally spaced. In one embodiment, the intact portion 81 and the plurality of flexible teeth 82 of the curved leaf springs 8 form a curved shape so that its outer surface may be complementary to the inner diameter of the hollow cylindrical spindle hub shaft 2. The plurality of curved leaf springs may form a continuous cylindrical structure so as to cover substantially all inner diameter of the hollow cylindrical spindle hub shaft 2 or form a non-continuous structure so as to cover only a portion of the inner diameter of the hollow cylindrical spindle hub shaft 2. The curved leaf springs can be mounted onto the hollow cylindrical spindle hub shaft by any suitable mechanical fasteners via the alignment of the shaft mounting holes 3 and spring mounting holes 84.

The curved leaf spring shown in FIG. 2 is in its free or extended condition. In one embodiment, the fingers 83 are initially manufactured with excessive length. The extra length of the fingers 83 is machined off while the curved leaf springs 8 are attached to the inner diameter of the hollow cylindrical spindle hub shaft 2. The spindle hub 1 is rotated while the fingers 83 are machined to the proper length. This procedure insures that the ends of the fingers 83 are all equidistant from the center of rotation of the spindle hub 1.

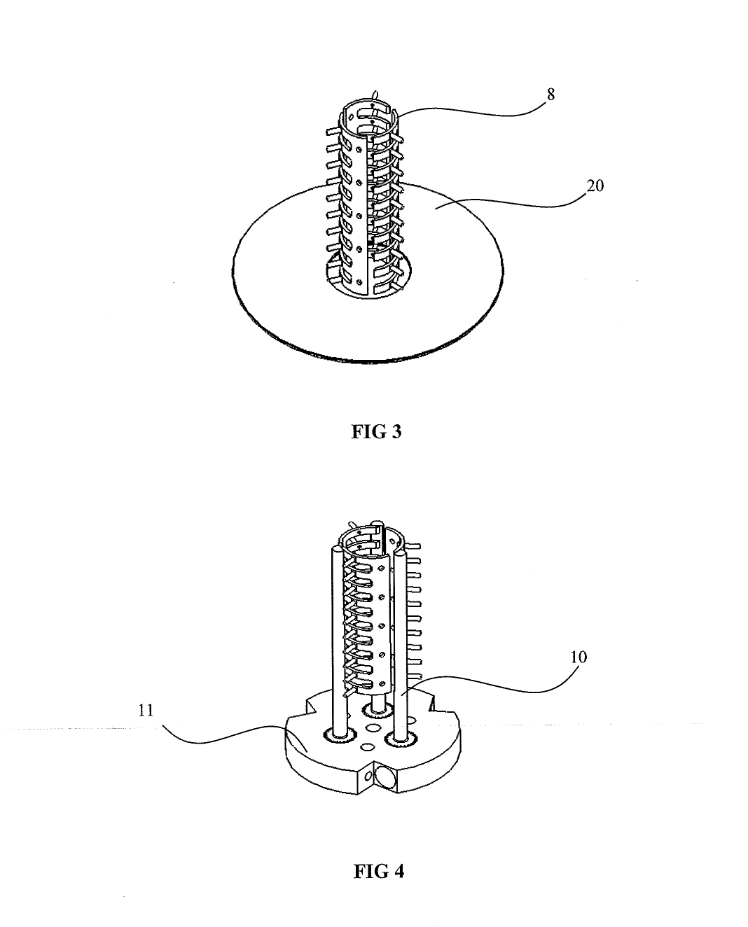

Now referring to FIG. 3, there is provided a perspective view of the interface between the fingers and a disk in accordance with one embodiment of the present invention. As shown in FIG. 3, three curved leaf springs 8 are equally spaced around the spin axis of the spindle hub so as to form a cylindrical configuration that is fit into the chamber of the hollow cylindrical spindle hub shaft 2, where the three fingers from the three curved leaf springs touch the inner diameter of the disk 20.

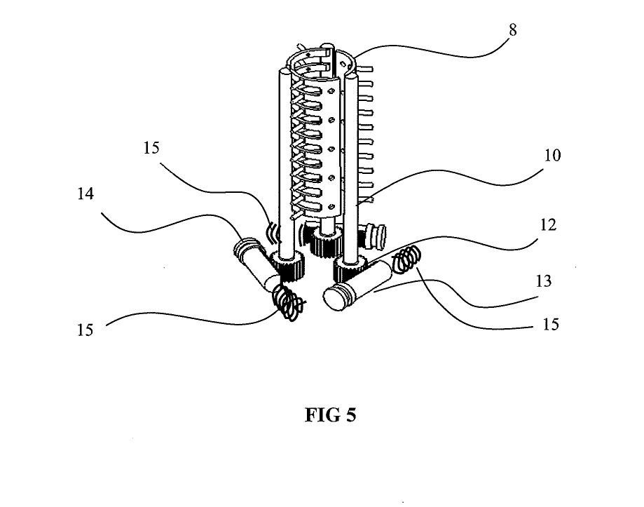

Now referring to FIGS. 4 and 5, there are provided perspective views of the curved leaf springs actuator system in accordance with one embodiment of the present invention. The curved leaf springs actuator system comprises a plurality of actuator rods 10, and an actuator rod controlling system for controlling the position of the plurality of actuator rods 10 so that the curved leaf springs 8 can be kept at any point between the extended position to the compressed position, and then the positions of the fingers 83 can be controlled by the plurality of actuator rods 10.

As shown in FIGS. 4 and 5, each actuator rod 10 is configured to have a flat surface so as to have a cam-like profile, where the flat surface is oriented roughly tangent to the outer surface of the curved leaf springs so that it does not press the curved leaf springs when in tangent condition. In one embodiment, one actuator rod 10 is employed for one curved leaf spring and positioned at the end of the teeth 82 of the curved leaf springs. The plurality of actuator rods 10 is mounted in the chamber of the hollow cylindrical spindle hub shaft 2 parallel to the axis of rotation.

The actuator controlling system comprises a plurality of pinion gears 12, a plurality of gear racks 13, a plurality of pistons 14, and a plurality of return springs 15, where the actuator controlling system is contained in a gear housing 11 in which the plurality of gear racks 13 is free to translate laterally. In one embodiment, the number of gear racks, pistons, and springs is determined by the number of actuator rods.

As shown in FIG. 5, one pinion gear 12 is attached to the bottom end of one actuator rod 10, and one pinion gear 12 meshes with the side of one gear rack 13. One gear rack 13 has a first end being attached with one piston 14 and a second end receiving one return spring 15; thereby when air pressure is applied to the plurality of pistons 14, it moves the pistons and causes the actuator rods 10 to rotate; when air pressure is removed, the return springs forces the gear racks back to their initial positions. In one embodiment, the initial position of the gear racks 13 is correspondent to the position of the actuator rods where the flat surface of the actuator rods is tangent with the curved leaf springs.

Now there is provided a more detailed description of the operation of the spindle hub 1 with its centering assembly.

The actuator rods 10 are initially in their tangent position with respect to the curved leaf springs 8 and the fingers 83 are in their free condition protruding through the finger holes 4 of the spindle hub. Then, air pressure is applied to the pistons 14, causing the pistons 14 to move the gear racks 13, where the moving gear racks rotate the actuator rods 10. This rotation causes a cam-like motion to occur at the interface of the curved leaf spring 8 and the actuator rods 10, resulting in a force being applied to the teeth 82 of the curved leaf springs 8. This force causes the curved leaf springs 8 to flex inward towards the center of the spindle hub so that the fingers 83 move inward and retract below the surface of the outer diameter of the hollow cylindrical spindle hub shaft 2.

When this retracted position is achieved, disks 20 may be stacked onto the hollow cylindrical spindle hub shaft 2 without interference with the fingers 83. After the disks 20 have been loaded onto the hollow cylindrical spindle hub shaft 2, the air pressure is removed from the pistons 14, resulting in a reversal of the motions. The pistons 14 and gear racks 13 return to their initial position. This action rotates the actuator rod 10 back to its tangent position. This reverse motion releases the curved leaf springs 8 allowing them to return to their extended position. As the fingers 83 protrude from the finger holes 4, they contact the inner diameter of the disks 20. This places a radial force on each disk, forcing them to move until they achieve an equilibrium condition. In this condition, the radial force on each disk has stabilized, resulting in the centering of the disks 20. If an automatic clamping system is incorporated into the spindle hub, the disk centering assembly can be adjusted to allow the automatic sequencing of the centering to occur prior to the clamping action.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. A centering assembly for centering a plurality of disks being assembled onto a spindle hub, said centering assembly comprising:
a plurality of curved leaf springs for providing means for centering the plurality of disks by contacting their inner diameters; and
a curved leaf springs actuator system for operating the plurality of curved leaf springs;
thereby the curved leaf springs actuator system controls the motion of the plurality of curved leaf springs so as to cause the plurality of curved leaf springs to contact the inner diameter of the disks, resulting in the centering of the disks being assembled on the spindle hub.

2. The centering assembly of claim 1, wherein the plurality of curved leaf springs forms a continuous cylindrical structure.

3. The centering assembly of claim 1, wherein the plurality of curved leaf springs forms a non-continuous cylindrical structure.

4. The centering assembly of claim 1, wherein one of the plurality of curved leaf springs is configured to have an intact portion and a plurality of flexible teeth extending from the intact portion, wherein the intact portion has a column of spring mounting holes for the mounting the curved leaf springs, and wherein the plurality of flexible teeth bears a plurality of fingers that are used to contact the inner diameter of the disks during centering.

5. The centering assembly of claim 4, wherein the plurality of flexible teeth is spaced from each other equally.

6. The centering assembly of claim 4, wherein the curved leaf springs actuator system comprises:
a plurality of actuator rods being positioned at the tips of the flexible teeth; and
an actuator rod controlling system for controlling the position of the plurality of actuator rods so that the curved leaf springs can be kept between an extended position to a compressed position, and then the positions of the fingers can be controlled by the plurality of actuator rods.

7. The centering assembly of claim 6, wherein one of the plurality of actuator rods is configured to have a flat surface so as to have a cam-like profile, where the flat surface is oriented roughly tangent to the outer surface of the curved leaf springs so that it does not press the curved leaf springs when in tangent condition.

8. The centering assembly of claim 6, wherein the actuator controlling system comprises:
a plurality of pinion gears, wherein one pinion gear is attached to the bottom end of one actuator rod; and
a plurality of gear racks, wherein the side of one gear rack meshes with one pinion gear, and wherein one gear rack has a first end being attached with one piston and a second end receiving one return spring; thereby when air pressure is applied to the piston, it moves the pistons and causes the actuator rods to rotate; when air pressure is removed, the return spring forces the gear rack back to its initial position.

9. A spindle hub being capable of centering disks being assembled, comprising:
a centering assembly comprising:
a plurality of curved leaf springs for providing means for centering the plurality of disks by contacting their inner diameters; and
a curved leaf springs actuator system for operating the plurality of curved leaf springs;
thereby the curved leaf springs actuator system controls the motion of the plurality of curved leaf springs so as to cause the plurality of curved leaf springs to contact the inner diameter of the disks, resulting in the centering of the disks being assembled on the spindle hub;
a hollow cylindrical spindle hub shaft having a chamber for receiving the centering assembly, wherein the disks are assembled at the outer diameter of the hollow cylindrical spindle hub shaft so that the assembled disks are centered by the centering assembly; and
a base being connected to the bottom end of the hollow cylindrical spindle hub shaft, wherein when the base interacts with a motorized spindle, resulting in the rotation of the spindle hub with assembled disks.

10. The spindle hub of claim 9, wherein the plurality of curved leaf springs forms a continuous cylindrical structure.

11. The spindle hub of claim 9, wherein the plurality of curved leaf springs forms a non-continuous cylindrical structure.

12. The spindle hub of claim 9, wherein one of the plurality of curved leaf springs is configured to have an intact portion and a plurality of flexible teeth extending from the intact portion, wherein the intact portion has a column of spring mounting holes for the mounting the curved leaf springs, wherein the plurality of flexible teeth bears a plurality of fingers that are used to contact the inner diameter of the disks during centering; and wherein the hollow cylindrical spindle hub shaft has a plurality of columns of shaft mounting holes and finger holes, wherein the shaft mounting holes are aligned with the spring mounting holes for mounting the curved leaf springs onto the inner diameter of the hollow cylindrical spindle hub shaft and the finger holes are channels for providing passes for the fingers of the centering assembly.

13. The spindle hub of claim 12, wherein the plurality of flexible teeth is spaced from each other equally; and wherein the plurality of flexible teeth is perpendicular to the spin axis of the spindle hub when the curved leaf springs are assembled inside the chamber of the hollow cylindrical spindle hub shaft.

14. The spindle hub of claim 12, wherein the fingers are initially manufactured with excessive length, and then the excessive length of the fingers is machined to proper length while the spindle hub is rotated; thereby the ends of the fingers are all equidistant from the center of rotation of the spindle hub.

15. The spindle hub of claim 12, wherein the curved leaf springs actuator system comprises:
a plurality of actuator rods being positioned at the tips of the flexible teeth; and
an actuator rod controlling system for controlling the position of the plurality of actuator rods so that the curved leaf springs can be kept at any point between an extended position to a compressed position, and then the positions of the fingers can be controlled by the plurality of actuator rods;
thereby the curved leaf springs actuator system controls the motion of the plurality of curved leaf springs so as to cause the plurality of curved leaf springs to contact the inner diameter of the disks, resulting in the centering of the disks being assembled on the spindle hub.

16. The spindle hub of claim 15, wherein one of the plurality of actuator rods is configured to have a flat surface so as to have a cam-like profile, where the flat surface is oriented roughly tangent to the outer surface of the curved leaf springs so that it does not press the curved leaf springs when in tangent condition.

17. The spindle hub of claim 15, wherein the actuator controlling system comprises:
a plurality of pinion gears, wherein one pinion gear is attached to the bottom end of one actuator rod; and
a plurality of gear racks, wherein the side of one gear rack meshes with one pinion gear, and wherein one gear rack has a first end being attached with one piston and a second end receiving one return spring; thereby when air pressure is applied to the piston, it moves the pistons and causes the actuator rods to rotate; when air pressure is removed, the return spring forces the gear rack back to its initial position.
